(19) United States
(12) Patent Application Publication
(10) Pub. No.: US 2024/0204404 A1
(43) Pub. Date: Jun. 20, 2024

(54) PHASE SHIFTER, PHASE TRANSFORMATION UNIT, AND PHASE TRANSFORMATION METHOD

(71) Applicant: GIGALANE CO., LTD., Hwaseong-si Gyeonggi-do (KR)

(72) Inventors: Jae Jun LEE, Hwaseong-si, Gyeonggi-do (KR); Dae Ho KIM, Hwaseong-si, Gyeonggi-do (KR); Eun Kuk PARK; Hee Seok JUNG, Hwaseong-si, Gyeonggi-do (KR)

(21) Appl. No.: 18/554,209

(22) PCT Filed: Jun. 9, 2022
(86) PCT No.: PCT/KR22/08151

§ 371 Date: Oct. 10, 2023

(30) Foreign Application Priority Data
Jul. 8, 2021 (KR) 10-2021-0089757
Mar. 10, 2022 (KR) 10-2022-0030208

(51) Int. Cl. H01Q 3/36

(52) U.S. Cl. CPC H01Q 3/36

(57) ABSTRACT

The present invention relates to a phase shifter comprising: an operation unit connected to a plurality of phase transformation units to synchronize respective phases changed through the plurality of phase transformation units; a driving unit having a motor with a rotary shaft, a plurality of gears rotating interlinked with the rotary shaft, and a screw connected to any one of the plurality of gears to transmit power to the operation unit, the driving unit driving the operating unit through the motor, the plurality of gears, and the screw, wherein the screw is seated on a seating portion provided on an outer side of the motor, and pivotally rotates on the seating portion.

### TECHNICAL FIELD

The present invention relates to a phase shifter, a phase conversion unit, and a phase conversion method.

### BACKGROUND ART

Recently, as a newly expanded fifth generation (5G) service is introduced in mobile communication systems, multiple-input multiple-output (MIMO) antenna technology is emerging.

In general, a beamforming technique is applied to the MIMO antenna technology in the 5G service. In such a beamforming technique, a phase shifter changes steering angles of beams radiated from antennas. In addition, the phase shifter includes a plurality of phase conversion units connected to a plurality of antennas to shift, that is, convert a phase of a signal transmitted to each antenna.

Meanwhile, base station equipment for providing the 5G service includes 64 antennas, and the number of phase conversion units of the phase shifter is also configured to correspond thereto. For example, a hybrid beamforming technique (2 sub-array type) in which two antennas are connected to one transceiver may have 32 phase conversion units.

As described above, when the number of phase conversion units increases, there is a problem in that phases converted through a plurality of phase conversion units are not synchronized.

The background technology of the invention has been prepared to facilitate the understanding of the present invention. It should not be construed as an admission that details described in the background technology of the invention are present as related art.

### DETAILED DESCRIPTION OF THE INVENTION

### Technical Problem

The present invention is directed to providing a phase shifter, a phase conversion unit, and a phase conversion method, which can synchronize phases converted by a plurality of phase conversion units.

Objects of the present invention are not limited to the above-described object, and other objects that are not mentioned will be able to be clearly understood by those skilled in the art from the following description.

### Technical Solution

A phase shifter according to an embodiment of the present invention includes an operation unit connected to a plurality of phase conversion units to synchronize phases changed through the plurality of phase conversion units, and a driving unit including a motor having a rotational shaft, a plurality of gears rotating in conjunction with the rotational shaft, and a screw connected to any one of the plurality of gears to transmit power to the operation unit, and configured to drive the operation unit through the motor, the plurality of gears, and the screw, wherein the screw is seated on a seating portion provided outside the motor and pivotally rotates on the seating portion.

At least one lubricant member may be provided in the seating portion, and the at least one lubricant member may reduce friction or wear due to the rotation of the screw between the seating portion and the screw.

The at least one lubricating member may be made of a material including polytetrafluoroethylene (PTFE), polyether ether ketone (PEEK), or polyetherimide (PEI).

The driving unit may further include a circulation member connected to the screw to drive the operation unit by circularly moving on the seating portion according to the rotation of the screw and converting the rotational motion of the screw into linear motion.

The driving unit may further include a stopping member through which the screw passes at one side or the other side of the seating portion and which restricts a movement range of the circulation member.

The stopping member may include a first stopping member and a second stopping member respectively provided at one side and the other side of the seating portion, and the circulation member may be circularly moves between the first stopping member and the second stopping member.

A first through hole through which the screw passes may be formed in the circulation member, and when the circulation member circularly moves, the circular movement of the circulation member may be stopped by an edge of the first through hole supported by an edge of the stopping member.

A first hooking protrusion may be formed on an edge of the first through hole, and the first hooking protrusion may be supported by being engaged with a second hooking protrusion formed on the edge of the stopping member.

A guide member may be provided at a point spaced apart from the screw at one side of the seating portion, a second through hole through which the guide member passes may be formed in the circulation member, and the circular movement of the circulation member may be guided by the guide member.

Other embodiment specifics are included in the detailed description and accompanying drawings.

### Advantageous Effects

According to the present invention, since a phase shifter includes a plurality of phase conversion units on a support frame and the plurality of phase conversion units are simultaneously operated by an operation unit and a driving unit connected thereto, it is possible to equally convert all of a plurality of phases.

Various and beneficial advantages and effects of the present invention are not limited to the above-described contents and will be able to be more readily understood in a process of describing specific embodiments of the present invention.

### BRIEF DESCRIPTION OF DRAWINGS

FIG. 1 is a top view of a phase shifter according to one embodiment of the present invention.

FIG. 2 is an exploded perspective view in which the phase conversion unit according to one embodiment of the present invention is sequentially disassembled for each component.

FIG. 3 is a perspective view of a driving unit according to one embodiment of the present invention.

FIG. 4 is a schematic diagram for describing a method of changing overlapping lengths of circuit patterns in the phase conversion unit according to one embodiment of the present invention.

FIG. 5 is a perspective view of a guide bar of an operation unit according to one embodiment of the present invention.

FIG. 6 is an enlarged cross-sectional view of region A illustrated in FIG. 1.

FIG. 7 is a perspective view of the phase conversion unit according to one embodiment of the present invention.

FIGS. 8 and 9 are perspective views for describing the structures of elastic members according to various embodiments of the present invention.

FIG. 10 is an enlarged perspective view of region B illustrated in FIG. 1.

FIG. 11 is a block diagram for describing an operating method of the phase shifter according to one embodiment of the present invention.

FIG. 12 is a view of a phase shifter according to another embodiment of the present invention.

FIG. 13 is a view of a driving unit installed in the phase shifter according to another embodiment of the present invention.

FIG. 14 is an exploded perspective view in which the driving unit installed in the phase shifter according to another embodiment of the present invention is sequentially disassembled for each component.

FIG. 15 is an enlarged view illustrating a circulation member and a stopping member of a seating portion in the driving unit installed in the phase shifter according to another embodiment of the present invention.

### MODES OF THE INVENTION

Hereinafter, embodiments of the present invention will be described in detail with reference to the accompanying drawings so that those skilled in the art to which the present invention pertains may easily carry out the present invention.

The present invention may be implemented in various different forms and is not limited to the embodiments described herein.

For reference, a phase conversion unit defined in the present invention may be generally understood as being a phase shifter.

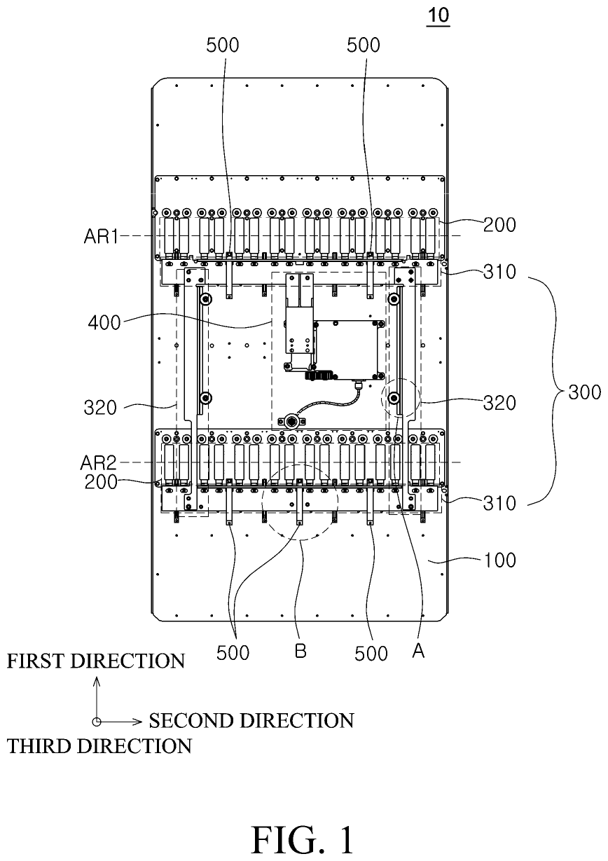

FIG. 1 is a top view of a phase shifter according to one embodiment of the present invention.

As illustrated in FIG. 1, a phase shifter 10 according to the present invention is a device for changing the steering angles of beams radiated from antennas and may shift, that is, convert phases of signals transmitted to the antennas through a plurality of phase conversion units 200.

To this end, the phase shifter 10 may include a support frame 100, the phase conversion unit 200, an operation unit 300, and a driving unit 400.

The plurality of phase conversion units 200 may be disposed on the support frame 100. The support frame 100 may be formed as a flat frame and made of a hard material capable of supporting the plurality of phase conversion units 200, for example, a metal material such as aluminum. The support frame 100 may be formed in a quadrangular shape in which the plurality of phase conversion units 200 are disposed in the form of an array. However, the material and shape of the support frame 100 are not limited to the above-described example.

The plurality of phase conversion units 200 may be disposed on the support frame 100 in the form of a plurality of arrays. Specifically, the plurality of phase conversion units 200 may be disposed on the support frame 100 in the form of arrays spaced apart from each other in a second direction, and the arrays of the phase conversion units 200 may be disposed as a plurality of arrays spaced apart from each other in a first direction.

In FIG. 1, a plurality of phase conversion units 200 in which a pair of arrays AR1 and AR2 are disposed vertically based on the center of the support frame 100, that is, at both sides of the support frame 100 in the second direction are illustrated, but the present invention is not limited thereto. For example, three or more arrays of the plurality of phase conversion units 200 may be disposed on the support frame 100.

The operation unit 300 may be connected to the plurality of phase conversion units 200 to synchronize phases converted through the plurality of phase conversion units 200. Specifically, the operation unit 300 may synchronize the phases by changing the entire length of transmission lines connected inside the plurality of phase conversion units 200, that is, signal lines connected to antennas, and a more detailed description thereof will be made below.

The driving unit 400 may drive the operation unit 300. Specifically, the driving unit 400 may drive the operation unit 300 through structural interlocking with the operation unit 300.

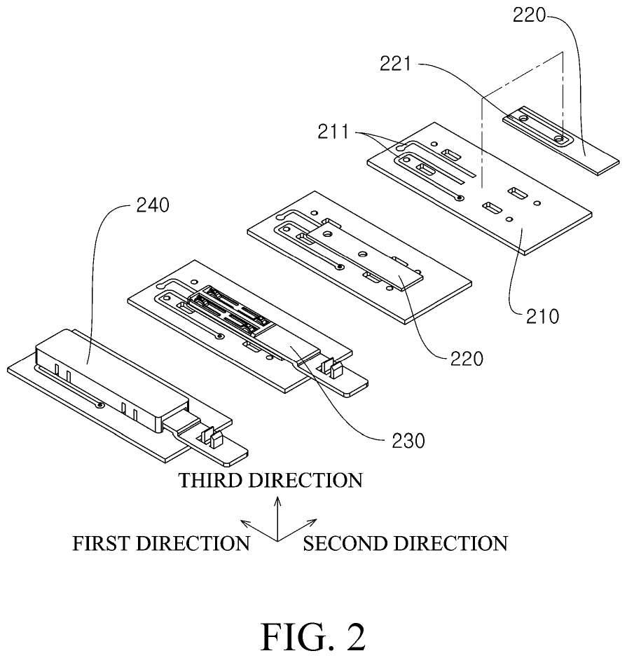

FIG. 2 is an exploded perspective view in which the phase conversion unit according to one embodiment of the present invention is sequentially disassembled for each component. For reference, FIG. 2 is a view illustrating that more components are disassembled toward the right.

As illustrated in FIG. 2, each of the plurality of phase conversion units 200 may include a first circuit board 210, a second circuit board 220, a movable member 230, and a housing 240.

According to the embodiment, the first circuit board 210 and the second circuit board 220 are printed circuit boards (PCBs), in which the first circuit board 210 may have a first circuit pattern 211, and the second circuit board 220 may have a second circuit pattern 221. In this case, the first circuit pattern 211 and the second circuit pattern 221 may constitute circuit patterns as parts of transmission lines that transmit signals to antennas.

A surface of the second circuit board 220, which has the second circuit pattern 221, may be disposed to face a surface of the first circuit board 210, which has the first circuit pattern 211, so that the second circuit pattern 221 may overlap and be connected to the first circuit pattern 211. Therefore, a partial region of the second circuit pattern 221 may overlap and be connected to the first circuit pattern 211.

An overlapping length between the second circuit pattern 221 and the first circuit pattern 211 may be changed according to the driving of the operation unit 300. Specifically, the second circuit board 220 having the second circuit pattern 221 may be disposed on one surface of the movable member 230, and as the movable member 230 connected to the operation unit 300 moves in the first direction, the overlapping length between the first circuit pattern 211 and the second circuit pattern 221, that is, the length of the circuit pattern, may be changed. For example, since the second circuit board 220 moves in the first direction together with the movable member 230 while the first circuit board 210 is stationary, the lengths of the circuit patterns may be changed as much as the second circuit board 220 moves in the first direction.

The housing 240 may be disposed on the first circuit board 210 to accommodate the first circuit pattern 211 and the second circuit pattern 221. According to the embodiment, the movable member 230 and the housing 240 may be made of a non-conductive material to prevent signals transmitted through the first circuit pattern 211 and the second circuit pattern 221 from being distorted.

Meanwhile, in FIG. 2, although it is illustrated that the first circuit pattern 211 is formed on the first circuit board 210, the first circuit pattern 211 may be formed on the housing 240. For example, a lower surface may be formed on the housing 240 instead of the first circuit board 210, and the first circuit pattern 211 may be formed on the lower surface of the housing 240, that is, a surface in contact with one surface of the movable member 230.

In addition, although it is illustrated that the second circuit pattern 221 is formed on the second circuit board 220, the second circuit pattern 221 may be formed on the movable member 230. In other words, since one or more of the first circuit board 210 and the second circuit board 220 may be omitted from the phase conversion unit 200, it is possible to reduce the number of man-hours for manufacturing the phase conversion unit 200.

Referring back to FIG. 1, the operation unit 300 may be connected to the plurality of phase conversion units 200 to synchronize a plurality of phases. Specifically, the operation unit 300 may include a plurality of operation bars 310 connecting one side of each of the plurality of phase conversion units 200 disposed in the form of arrays, and one or more guide bars 320 connecting the plurality of operation bars 310. According to the embodiment, the plurality of operation bars 310 may be disposed to correspond to the number of arrays of the plurality of phase conversion units 200. For example, as a pair of arrays AR1 and AR2 are disposed, a pair of operation bars 310 may be disposed.

The plurality of operation bars 310 may be connected to the one or more guide bars 320 so that the plurality of operation bars 310 may simultaneously move in the first direction.

The one or more guide bars 320 may be disposed in the form of a pair of guide bars 320 connecting both sides of the plurality of operation bars 310. When the pair of guide bars 320 connect both sides of the operation bars 310, the movement of the plurality of phase conversion units 200 may be corrected by the guide bars 320 connected to the other side of the operation bar 310 even when the movement of the guide bars 320 connected to one side of the operation bar 310 is distorted.

According to the embodiment, although it is illustrated that the pair of guide bars 320 are connected to each of both sides of the pair of operation bars 310 in FIG. 1, respectively, if necessary, three or more operation bars 310 may be connected to the pair of guide bars 320. For example, the pair of a first guide bar 320 and a second guide bar 320 connected to both sides of the first operation bars 310 may be connected to both sides of a second operation bar 310 and a third operation bar 310, respectively, so that the first operation bar 310, the second operation bar 310, and the third operation bar 310 may be simultaneously moved in the first direction through the first guide bar 320 and the second guide bar 320.

As described above, the plurality of operation bars 310 may simultaneously move in the first direction through the one or more guide bars 320. In addition, while the plurality of operation bars 310 move in the first direction through the plurality of guide bars 320, the plurality of operation bars 310 may move stably and simultaneously without being distorted at any one side.

In addition, as the plurality of operation bars 310 simultaneously move, the operation units 300 may equally convert, that is, synchronize a plurality of phases. The driving unit 400 may be disposed on the support frame 100 to drive the operation unit 300. Specifically, as the driving unit 400 is connected to at least one of the plurality of operation bars 310, the driving unit 400 may provide a driving force capable of moving the plurality of operation bars 310 in the first direction. For example, the driving unit 400 may be an actuator.

So far, the phase shifter 10 according to one embodiment of the present invention has been described. According to the present invention, since the phase shifter 10 includes the plurality of phase conversion units 200 on the support frame 100 and the plurality of phase conversion units 200 are simultaneously operated by the operation unit 300 and the driving unit 400 connected thereto, it is possible to synchronize all of the plurality of phases equally.

Hereinafter, a structure of the driving unit 400 for operating the plurality of phase conversion units 200 will be described.

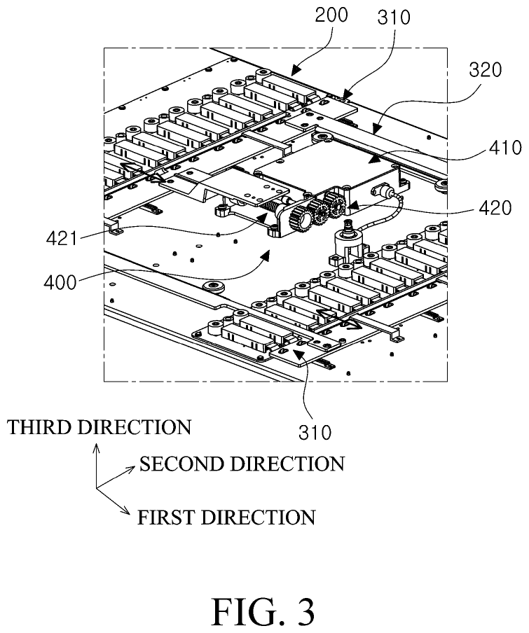

FIG. 3 is a perspective view of a driving unit according to one embodiment of the present invention.

As illustrated in FIG. 3, the driving unit 400 may include a motor 410 and a plurality of gears 420. The motor 410 may have a rotational shaft, and the plurality of gears 420 may be rotated in conjunction with the rotational shaft of the motor 410. For example, a first rotating gear among the plurality of gears 420 may be rotated in conjunction with the rotational shaft of the motor 410, and a gear that is interlocked with the first rotating gear may be rotated.

In addition, the rotation of the plurality of gears 420 may be interlocked with the movement of the plurality of operation bars 310. Therefore, the plurality of gears 420 may equally move the plurality of operation bars 310 and the movable members 230 of the plurality of phase conversion units 200 connected thereto in the first direction through a driving force transmitted from the motor 410.

For example, a finally rotating gear among the plurality of gears 420 and any one of the plurality of operation bars 310 may be connected with a screw 421 so that the rotational motion of the gear may be converted into linear motion of the plurality of operation bars 310.

Meanwhile, since a plurality of gears are formed, a rotational speed of the motor 410 may be decreased according to a gear ratio, and the moving speed of the plurality of operation bars 310 may be decreased to be prevented from being faster than necessary.

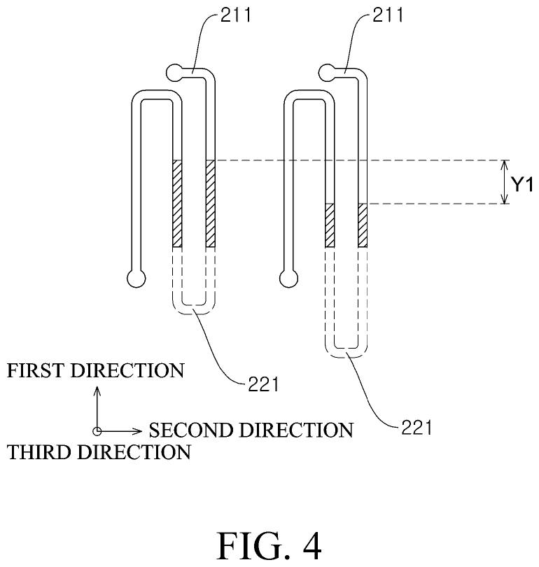

FIG. 4 is a schematic diagram for describing a method of changing overlapping lengths of circuit patterns in the phase conversion unit according to one embodiment of the present invention.

As illustrated in FIG. 4, the first circuit patterns 211 and the second circuit patterns 221 in the plurality of phase conversion units 200 may overlap in regions indicated by hatched lines. As the overlapping length increases, the length of the circuit pattern may decrease, and as the overlapping length decreases, the length of the circuit pattern may increase.

As the motor 410 and the plurality of gears 420 are driven, the overlapping lengths of the first circuit patterns 211 and the second circuit patterns 221 may be changed by the plurality of operation bars 310, and phases may be converted through a length difference value Y1 of the circuit patterns.

In other words, a driving range of the plurality of operation bars 310 may correspond to the overlapping length of the first circuit pattern 211 and the second circuit pattern 221. For example, the driving range of the plurality of operation bars 310 may be in a range of 0 mm to 14 mm, and the overlapping length of the circuit patterns may be in a range of 0 mm to 14 mm.

So far, the driving unit 400 according to one embodiment of the present invention has been described. Hereinafter, a structure of the operation unit 300 operated by the driving force generated by the driving unit 400 will be described.

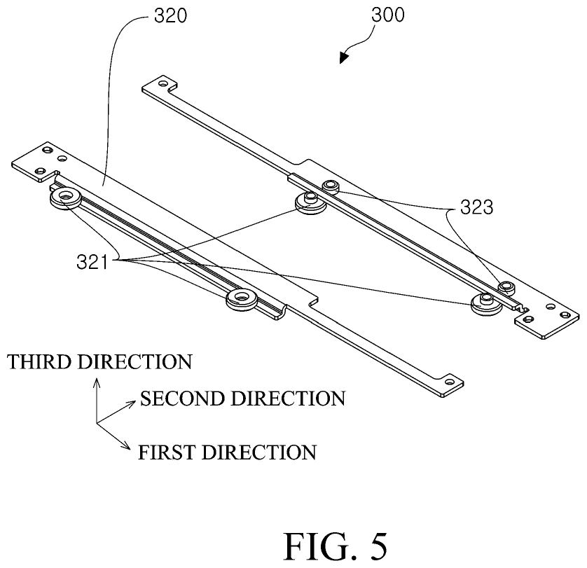

FIG. 5 is a perspective view of a guide bar of an operation unit according to one embodiment of the present invention. For reference, the left drawing of FIG. 5 is a view of the guide bar viewed from above, and the right drawing of FIG. 5 is a view of the guide bar viewed from below.

As illustrated in FIG. 5, the guide bar 320 may be moved by the driving unit 400 in the first direction, and for smooth movement in the first direction, a first guide roller 321 and a second guide roller 323 may be further included in one region.

In addition, each of the guide bars 320 may include two first guide rollers 321 and two second guide rollers 323, and the number of first guide rollers 321 and second guide rollers 323 may be one or three or more, respectively, as needed.

Meanwhile, the movement of the guide bar 320 in the second direction and the third direction may be restricted by a coupling structure of the first guide roller 321 and the second guide roller 323, and the guide bar 320 may stably move in the first direction.

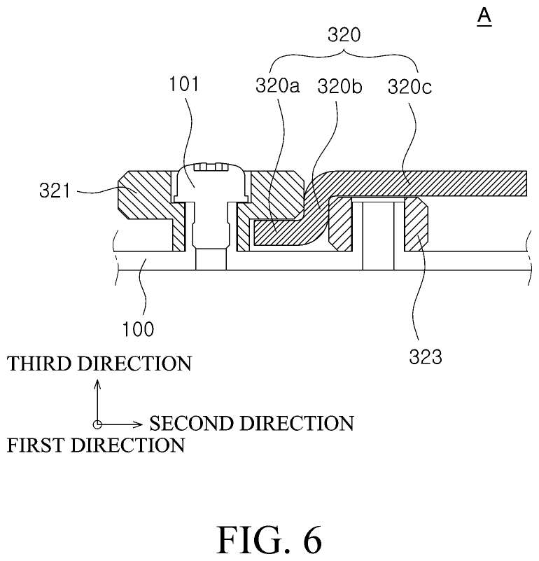

FIG. 6 is an enlarged cross-sectional view of region A illustrated in FIG. 1.

As illustrated in FIG. 6, the guide bar 320 may have a shape in which a cross section viewed from the front of the phase shifter 10 (with respect to the first direction) is bent, and the guide bar 320 may be divided into a first guide portion 320a, a second guide portion 320b, and a third guide portion 320c based on the bent portion.

The first guide portion 320a may be disposed to face the support frame 100, and the second guide portion 320b may be bent from the first guide portion 320a to extend in a direction away from the support frame 100. The third guide portion 320c may be bent from the second guide portion 320b to extend parallel to the first guide portion 320a.

The first guide roller 321 may be disposed above the first guide portion 320a. Specifically, a lower surface of the first guide roller 321 may be in contact with the first guide portion 320a, and a side surface thereof may be in contact with one side surface of the second guide portion 320b.

The second guide roller 323 may be disposed under the third guide portion 320c. Specifically, an upper surface of the second guide roller 323 may be in contact with the third guide portion 320c, and a side surface thereof may be in contact with the other side surface of the second guide portion 320b.

The first guide roller 321 and the second guide roller 323 may restrict the movement of the guide bar 320 in a second direction perpendicular to the first direction on the plane of the support frame 100 and restrict the movement of the guide bar 320 in a third direction perpendicular to the first direction and the second direction on the same plane. Specifically, the movement of the second guide portion 320b to one side (right side where the second guide roller 323 is disposed) in the second direction may be restricted by the first guide roller 321, and the movement of the second guide portion 320b to the other side (left side where the first guide roller 321 is disposed) in the second direction may be restricted by the second guide roller 321. In addition, the movement of the first guide portion 320a to one side (upper side where the first guide roller 321 is disposed) in the third direction may be restricted by the first guide roller 321, and the movement of the third guide portion 320c to the other side (lower side where the second guide roller 323 is disposed) in the third direction may be restricted by the second guide roller 323.

As described above, although the movement of the guide bar 320 in the second direction and the third direction may be restricted through the first guide roller 321 seated at one side of the guide bar 320 and the second guide roller 323 seated at the other side thereof, the guide bar 320 may smoothly move in the first direction.

In addition, a rotational shaft positioned on the plane of the support frame 100 may be inserted into the first guide roller 321, and the first guide roller 321 may be fixed to the rotational shaft through a fixing member 101. In addition, a rotational shaft positioned on the plane of the support frame 100 may be inserted into the second guide roller 323. Although not illustrated in the drawing, the second guide roller 323 may also be fixed to the rotational shaft through a separate fixing member (not illustrated) like the first guide roller 321.

As the first guide roller 321 and the second guide roller 323 may rotate about rotational shafts disposed parallel to each other, the first guide roller 321 and the second guide roller 323 may correspondingly restrict the movement of the guide bar 320 in the second direction and the third direction, and thus more smoothly restrict the movement of the guide bar 320 in the second direction and the third direction.

In addition, the first guide roller 321 and the second guide roller 323 may be made of a material capable of minimizing damage caused by friction. According to the embodiment, the first guide roller 321 and the second guide roller 323 may be made of a material resistant to wear, such as heat-resistant plastic, and specifically made of any one of polyphenylene sulfide (PPS), a liquid crystal polymer (LCP), and polytetrafluoroethylene (PPTE).

As described above, since the first guide roller 321 and the second guide roller 323 are made of a material resistant to wear, it is possible to improve the durability of the phase shifter 10 without causing a reduction in the performance of restricting the movement of the guide bar 320 due to wear of the roller while the guide bar 310 repeatedly moves.

So far, the structure of the operation unit 300 according to one embodiment of the present invention has been described. Hereinafter, a structure of the phase conversion unit 200 for changing the overlapping length of the first circuit pattern 211 and the second circuit pattern 221 according to the driving of the operation unit 300 will be described.

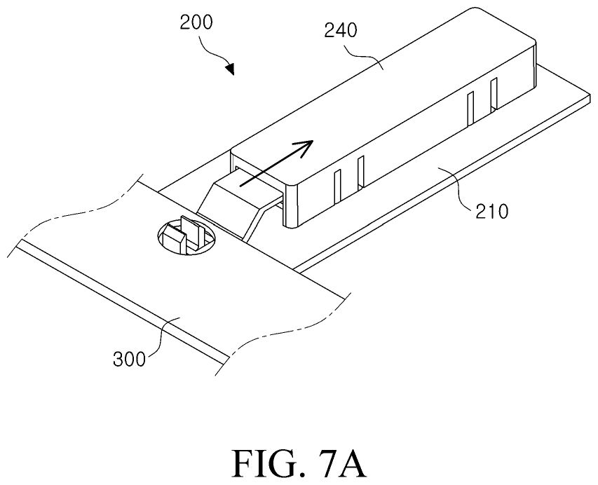

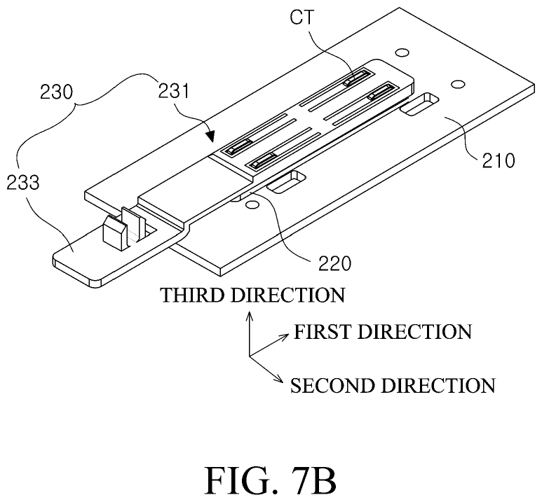

FIG. 7 is a perspective view of the phase conversion unit according to one embodiment of the present invention. For reference, the upper drawing of FIG. 7 is a view including a housing, and the lower drawing of FIG. 7 is a view excluding the housing.

As illustrated in FIG. 7, each of the plurality of phase conversion units 200 may further include the movable member 230 for changing the overlapping length of the first circuit pattern 211 and the second circuit pattern 221. Specifically, referring to FIG. 7B, the movable member 230 may have a shape in which a cross section viewed from the side (in the second direction) of the phase shifter 10 is bent and include a first movable portion 231 and a second movable portion 233 partitioned based on the bent shape.

The second circuit board 220 may be disposed on the first movable portion 231, and the second movable portion 233 may extend from the first movable portion 231 and be fixedly coupled to the operation unit 300. For example, a protruding part of the second movable portion 233 may be fixedly coupled by being inserted into a hole of the operation unit 300. In this case, one end of the protruding part may have a hook shape for preventing the protruding part from being separated after being inserted into the hole of the operation unit 300.

The movable member 230 may be moved by the operation unit 300 in the first direction together with the second circuit board 220 to change the overlapping length of the first circuit pattern 211 and the second circuit pattern 221.

According to the embodiment, the second circuit board 220 disposed on the movable member 230 may be in a state of being spaced a minute distance from the first circuit board 210 in the third direction, and the second circuit pattern 221 may be in close contact with the first circuit pattern 211 through an elastic force of the movable member 230. Specifically, the movable member 230 may be formed in an elastic structure that presses the second circuit board 220 in a direction in which the first circuit board 210 is positioned through the elastic force so that the second circuit pattern 221 may come into close contact with the first circuit pattern 211. For example, the elastic structure may be a structure in which a shape or a material has an elastic force.

First, a structure in which the shape of the movable member 230 has the elastic force will be described.

As illustrated in FIG. 7, the first movable portion 231 may have a cantilever shape CT with free ends. Specifically, while the movable member 230 moves in the first direction, the free ends of the cantilever shape CT provided on the first movable portion 231 may come into contact with the inner surface of the housing 240 to obtain an elastic force. The first movable portion 231 obtaining the elastic force may press the second circuit board 220, and the second circuit pattern 221 of the pressed second circuit board 220 may come into close contact with the first circuit pattern 211. In this case, the first movable portion 231 may have an elastic force that maintains the close contact between the first circuit pattern 211 and the second circuit pattern 221 and does not press the second circuit board 220 more than necessary.

The movable member 230 may be made of a plastic-based material so that the first movable portion 231 may easily have the cantilever shape CT.

In FIG. 7, although it is illustrated that the free ends of the cantilever shape CT provided on the first movable portion 231 are in contact with the inner surfaces of the housing 240 to obtain the elastic force, the present invention is not limited thereto. For example, the free ends of the cantilever shape CT provided on the first movable portion 231 may be in contact with the second circuit board 220 to obtain an elastic force.

As described above, by forming the shape of the movable member 230 in a structure having an elastic force, the close contact between the first circuit board 210 and the second circuit board 220 is maintained, and it is possible to prevent the circuit patterns from being damaged by not pressing more than necessary.

Next, a structure in which the material of the movable member 230 has an elastic force will be described.

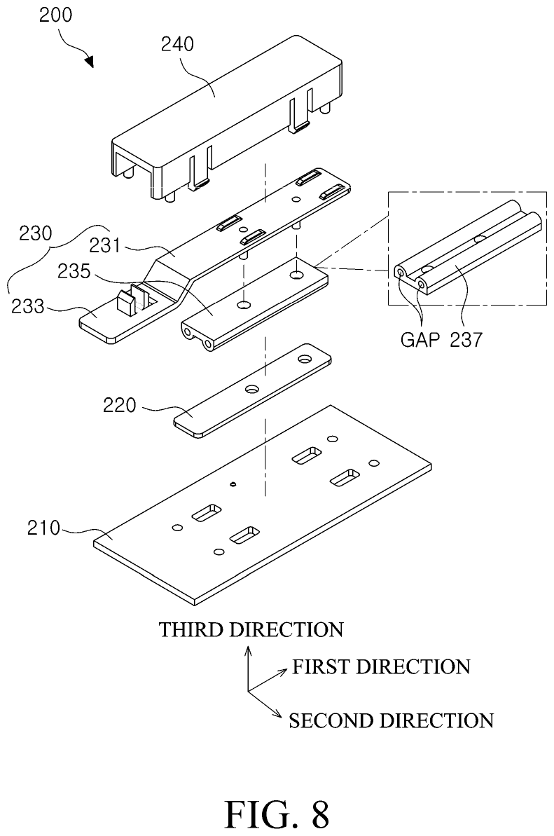

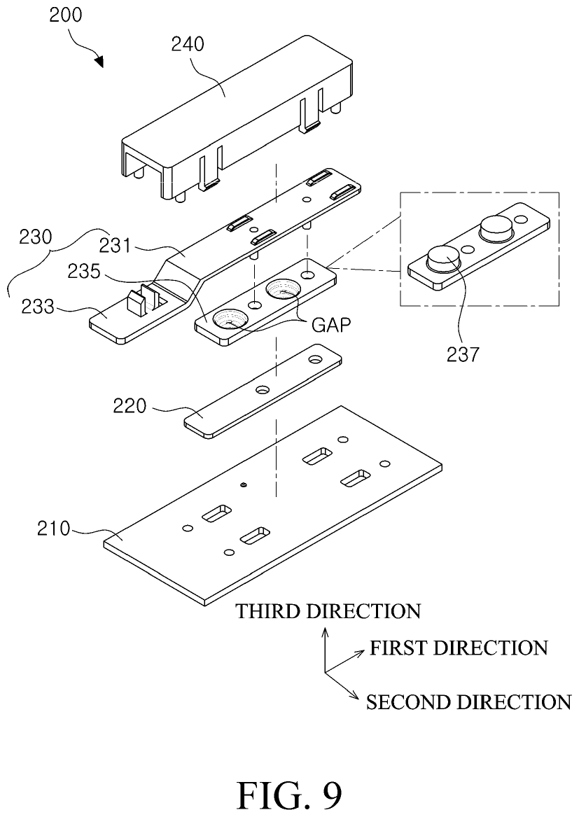

FIGS. 8 and 9 are perspective views for describing the structures of elastic members according to various embodiments of the present invention.

As illustrated in FIG. 8, the movable member 230 may further include an elastic member 235 for providing an elastic force.

The elastic member 235 may be disposed between the second circuit board 220 and the first movable portion 231, and thus may press the second circuit board 220 in a direction in which the first circuit board 210 is positioned. For example, the elastic member 235 may be made of an elastic material such as rubber or silicon.

Although not illustrated in the drawings, a plurality of through holes may be formed in the elastic member 235 to improve the mobility of the second circuit board 220 by decreasing the elastic force of the elastic member 235.

As illustrated in FIGS. 8 and 9, the elastic member 235 may further include protrusions 237.

The protrusions 237 may be disposed on at least one of both surfaces of the elastic member 235 in contact with the first movable portion 231 or the second circuit board 220. For example, the protrusions 237 may be disposed on one surface of the elastic member 235 in contact with the first movable portion 231 or disposed on both surfaces of the elastic member 235 to be in contact with the first movable portion 231 and the second circuit board 220.

When the protrusions 237 are disposed on the elastic member 235, a pressing force may be partially concentrated through the protrusions 237 to press the second circuit board 200 instead of entirely pressing the second circuit board 200 through the surface of the elastic member 235, thereby making the pressing easier.

According to the embodiment, by forming predetermined empty spaces GAP inside the protrusions 237 in the first direction, it is possible to facilitate the pressing and prevent an excessive pressing force from being applied to the second circuit board 220.

As illustrated in FIG. 9, the protrusion 237 may have a predetermined empty space GAP in an internal region.

When the elastic member 235 is made of an elastic material, the movement of the second circuit board 220 may be hindered when the pressing force of the second circuit board 220 toward the first circuit board 210 becomes larger than necessary. Therefore, it is possible to decrease the pressing force by forming the protrusions 237 on the elastic member 235 and forming the predetermined empty spaces GAP in the internal regions of the protrusions 237. In this case, as the second circuit board 220 presses the first circuit board 210 through the protrusions 237, the empty spaces GAP of the protrusions 237 may be compressed. In other words, the empty spaces GAP may be crushed by being pressed between the second circuit board 220 and the movable member 230.

As described above, the predetermined empty spaces GAP formed in the internal regions of the protrusions 237 may decrease the pressing force, thereby maintaining the close contact and improving the movement of the second circuit board 220.

So far, the phase conversion unit 200 according to one embodiment of the present invention and the internal components thereof have been described. The above-described shape and material of the phase conversion unit 200 are not limited to the above-described example.

Hereinafter, a structure for improving the durability of the phase shifter 10 in which the plurality of phase conversion units are disposed will be described.

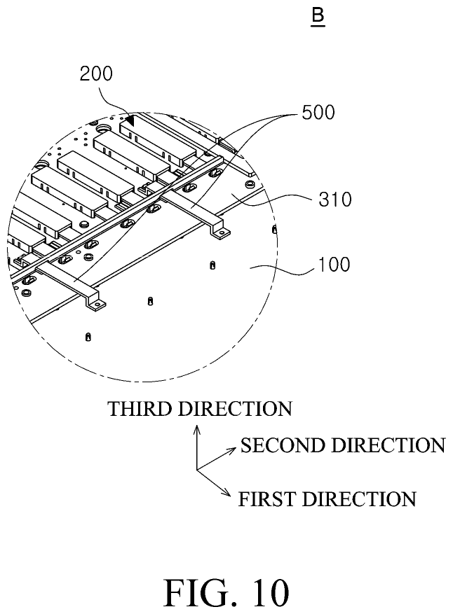

FIG. 10 is an enlarged perspective view of region B illustrated in FIG. 1.

As illustrated in FIG. 10, the phase shifter 10 may further include a fixing unit 500.

The fixing unit 500 may be formed in an arch shape in which both sides are fixed to the support frame 100, and an opening may be formed between both sides fixed to the support frame 100.

One or more among the plurality of operation bars 310 may pass through the opening formed between the support frame 100 and the fixing unit 500, and the movement of the corresponding operation bar 310 in the third direction perpendicular to the first direction and the second direction may be restricted.

As described above, by restricting the movement of the operation bar 310 in the third direction through the fixing unit 500, the operation bar 310 may maintain a stable state without being lifted in the third direction while the operation bar 310 moves in the first direction.

According to the embodiment, although it is illustrated that the fixing unit 500 is disposed on each of the plurality of operation bars 310 in FIG. 1, if necessary, the fixing unit 500 may not be disposed on the operation bar 310 among the plurality of operation bars 310, which is directly connected to the driving unit 400. For example, the fixing unit 500 may be disposed on the operation bar 310 whose operation is not directly interlocked with the driving unit 400 to restrict only the movement of the corresponding operation bar 310. This is because the driving unit 400, instead of the fixing unit 500, may restrict the movement of the operation bar 310 in the third direction.

Hereinafter, a series of methods for converting the phase of the phase shifter 10 will be described.

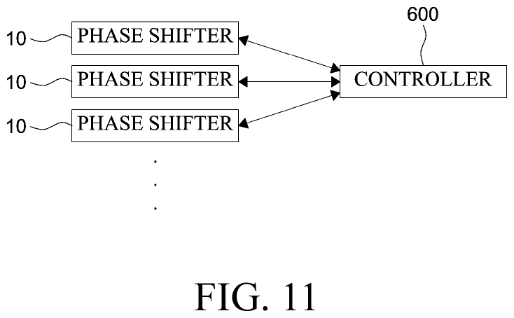

FIG. 11 is a block diagram for describing an operating method of the phase shifter according to one embodiment of the present invention.

The phase shifter 10 may include the support frame 100, the plurality of phase conversion units 200, the operation unit 300, and the driving unit 400, and since the components are the same as those of the phase shifter 10 illustrated in FIGS. 1 to 10, a detailed description thereof will be omitted.

As illustrated in FIG. 11, the phase shifter 10 may further include a controller 600 for controlling the operation of the phase shifter 10. Specifically, the controller 600 may provide operation commands, such as electrical signals, for operating the plurality of phase conversion units 200 to the driving unit 400, and these operation commands may be implemented in a computer readable storage medium in which commands executable by a processor are recorded.

According to the embodiment, the controller 600 may store attribute values of the motor 410 and the plurality of gears 420 of the driving unit 400 to control the operation of the driving unit 400. For example, the controller 20 may store the number of gear teeth of the plurality of gears 420, a rotational ratio of the plurality of gears 420, etc.

According to the embodiment, as illustrated in FIG. 11, the controller 600 may control the operation of a plurality of phase shifters 10, or the operation may be controlled through a controller 600 individually connected to the plurality of phase shifters 10.

According to the embodiment, the controller 600 may convert the phase of the phase shifter 10 based on a value input from a manager.

First, the controller 600 may acquire an input value corresponding to a phase to be converted. As one example of the input value, the controller 600 may acquire a phase conversion value of the phase shifter 10 as the input value. Here, the phase conversion value may be in a range of 0° to 12° tilt, but may not be limited thereto.

As another example of the input value, the controller 600 may acquire an overlapping length change value of the circuit patterns in the phase conversion unit 200 or a driving range value of the operation unit 300 as the input value. Here, the overlapping length value of the circuit patterns and the driving range value of the operation unit 300 may be in a range of 0 mm to 14 mm, but may not be limited thereto.

Next, after acquiring the input value, the controller 600 may generate a result value for equally converting the phases through the plurality of phase conversion units 200 using the input value and a reference value pre-stored in the controller 20. Specifically, the reference value may include a calculation formula or comparison data. For example, the calculation formula may be an arithmetic operation for generating a result value according to an input value, and the comparison data may be a table in which a plurality of input values and result values according to the input values are pre-calculated and listed. In other words, since the result values according to the input values are already derived in the pre-stored comparison data, the controller 600 may match the result values based on the input values.

As one example of the reference value, the reference value stored in the controller 600 may include a relative ratio calculation formula or comparison data generated based on a conversion range of the input value and the driving range of the operation unit 300. Here, the conversion range of the input value may be the phase conversion range (e.g., in a range of 0° to 12° tilt) of the phase conversion unit 200, and the driving range of the operation unit 300 may be a change range (e.g., in a range of 0 mm to 14 mm) of the overlapping length of the circuit patterns. More specifically, the relative ratio calculation formula may be a formula for determining whether the operation unit 300 should be moved Y mm in order to convert the phase by X°. For example, when the controller 600 inputs a tilt angle of the beam (direction of the beam tilted by 6°) into the relative ratio calculation formula in which the reference value is reflected, the controller 600 may obtain a movement length value (7 mm) of the operation unit 300 as an output. In other words, the controller 600 may calculate an output value in which the length of the circuit pattern increases by 7 mm through the relative ratio calculation formula.

As another example of the reference value, the reference value stored in the controller 600 may include a gear ratio calculation formula or comparison data generated based on the plurality of gears 420. Here, the gear ratio calculation formula is data that may be obtained from the number of teeth of the gears 420, and the controller 600 may store the gear ratio calculation formula (e.g., the number of teeth of a driven gear/the number of teeth of a driving gear) of the plurality of gears 420 and input the gear ratio calculation formula in the calculation process of generating a result value for an input value.

Next, the controller 600 may convert each phase by driving the operation unit 300 and the driving unit 400 based on the result value after generating the result value. For example, the result value may be an operation command controlling a rotational amount of the driving unit 400 for controlling a change in lengths of the circuit pattern, that is, the movement length of the operation unit 300.

According to the embodiment, the controller 600 may control the operation unit 300 to be driven through the driving unit 400 based on the generated result value and control a driving speed depending on whether a load is present. Specifically, the result value may include consecutive values for driving the operation unit 300 at a low speed or a high speed through the driving unit 400, and the operation unit 300 may be driven at a low speed or a high speed through the driving unit 400 based on the consecutive values.

The controller 600 may drive the operation unit 300 at a low speed through the driving unit 400 in a preset range according to the result value, and when a load is not applied to the driving unit 400 while the driving unit 400 is driven in the preset range upon driving at a low speed, the controller 20 may drive the operation unit 300 at a high speed through the driving unit. In this case, “load” may refer to a state in which the operation unit 300 is not driven because it is caught on an obstacle.

As described above, since the controller 20 may drive the operation unit 300 at a low speed in the preset range through the driving unit 400 and then drive the operation unit 300 at a high speed, it is possible to prevent the operation unit 300 from being damaged by the obstacle while being driven at a high speed.

In addition, the operation of the operation unit 300 and the driving unit 400 may be sequentially performed without stopping according to a change in the driving speed.

Hereinafter a phase shifter according to another embodiment of the present invention will be described.

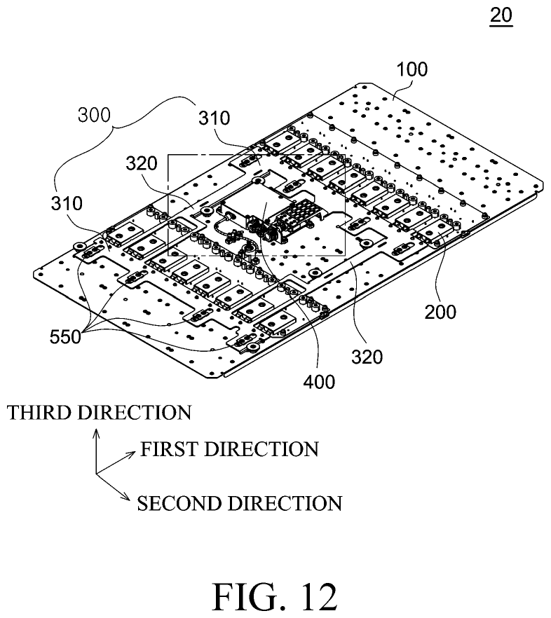

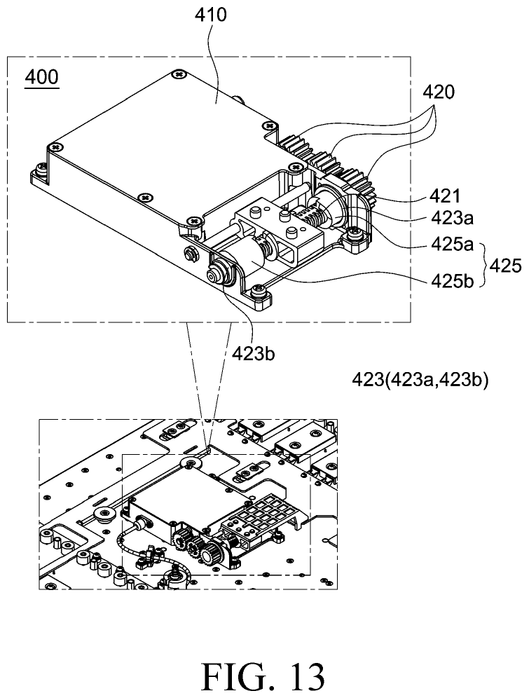

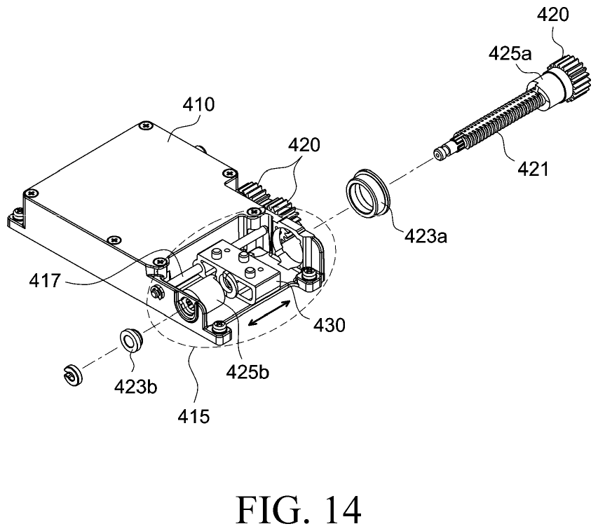

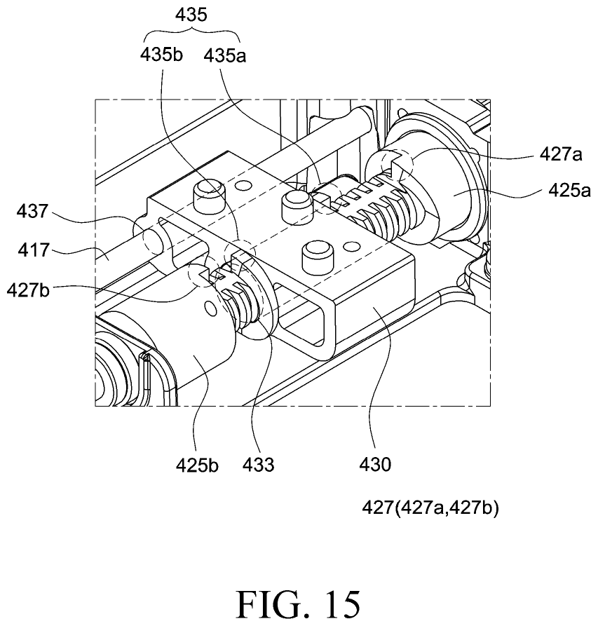

FIG. 12 is a view of a phase shifter according to another embodiment of the present invention. FIG. 13 is a view of a driving unit installed in the phase shifter according to another embodiment of the present invention. FIG. 14 is an exploded perspective view in which the driving unit installed in the phase shifter according to another embodiment of the present invention is sequentially disassembled for each component. FIG. 15 is an enlarged view illustrating a circulation member and a stopping member of a seating portion in the driving unit installed in the phase shifter according to another embodiment of the present invention.

Like the phase shifter 10 described above, the phase shifter 20 according to another embodiment of the present invention includes the support frame 100, the plurality of phase conversion units 200 disposed on the support frame 100, the operation unit 300 connected to the plurality of phase conversion units 200 to synchronize phases changed through the plurality of phase conversion units 200, and the driving unit 400 for driving the operation unit 300, in which the driving unit 400 may include the motor 410 having a rotational shaft, the plurality of gears 420 rotating in conjunction with the rotational shaft, and the screw 421 connected to any one of the plurality of gears 420 to transmit power to the operation unit 300 and drive the operation unit 300 through the motor 410, the plurality of gears 420, and the screw 421.

The screw 421 is seated on a seating portion 415 provided outside the motor 410 and pivotally rotates on the seating portion 415.

The screw 421 may be a screw in which a circulation member 430 (e.g., a nut) circulates (i.e., the circulation member moves back and forth along the screw), such as a lead screw or a ball screw.

In addition, at least one lubricating member 423 may be provided in the seating portion 415, and the at least one lubricating member 423 may reduce friction or wear due to the rotation of the screw 421 between the seating portion 415 and the screw 421.

Specifically, referring to FIGS. 13 and 14, the lubricating member 423 may include a first lubricating member 423a and a second lubricating member 423b respectively provided at one end and the other end of the screw 421, the seating portion 415 is formed in a through hole shape which protrudes from a side surface of the motor 410 and in which the screw 421 may be seated, and the screw 421 is seated by passing through the seating portion 415.

Any one of the plurality of gears 420 is coupled to an end portion of the screw 421, the gear 420 is engaged with the other gears 420 to receive a driving force from the motor 410, and the screw 421 receiving a rotational force converts rotational motion into linear motion through a screw thread formed in a circumferential direction and a circulation member connected to the screw thread.

In this case, since the screw 421 seated on the seating portion 415 is repeatedly rotated, friction or wear may occur at a portion in contact with the seating portion 415, and thus dust may be generated, resulting in problems such as reduced durability of the phase shifter, a malfunction of the phase conversion unit, and reduced efficiency of driving force transmission.

Therefore, in the phase shifter according to another embodiment of the present invention, by arranging one or more lubrication members 423 and 425 at the corresponding point(s), it is possible to minimize friction and wear occurring between the screw 421 and the seating portion 415 and prevent the generation of dust, thereby maintaining the durability of the phase shifter and preventing a malfunction of the phase conversion unit.

In this case, the one or more lubricating members 423 and 425 may be made of a material including polytetrafluoroethylene (PTFE), polyether ether ketone (PEEK), or polyetherimide (PEI). A material such as polytetrafluoroethylene (PTFE), polyether ether ketone (PEEK), or polyetherimide (PEI) is a material capable of functioning as a lubricant that has strong friction or wear resistance and is soft.

The driving unit 400 may further include the circulation member 430 connected to the screw 421 to drive the operation unit 300 by being moved circularly on the seating portion 415 according to the rotation of the screw 421 and converting the rotational motion of the screw 421 into linear motion.

The driving unit 400 may further include a stopping member 425 through which the screw 421 passes at one side or the other side of the seating portion 415 and which restricts a movement range of the circulation member 430. In this case, a section in which the circulation member 430 moves may be set according to a length of the stopping member 425.

The stopping member 425 may include a first stopping member 425 and a second stopping member 425 respectively provided at one side and the other side of the seating portion 415, and the circulation member 430 may be moved circularly between the first stopping member 425 and the second stopping member 425.

A first through hole 433 through which the screw 421 passes may be formed in the circulation member 430, and when the circulation member 430 circularly moves, the circular movement of the circulation member 430 may be stopped by an edge of the first through hole 433 supported by an edge of the stopping member 425.

A first hooking protrusion 435 may be formed on an edge of the first through hole 433, and the first hooking protrusion 435 may be supported by being engaged with a second hooking protrusion 427 formed on the edge of the stopping member 425. In this case, since each of the first hooking protrusions 435 (435a and 435b in FIG. 15) may be formed at one of both end portions of the first through hole 433, each of the second hooking protrusions 427 (427a and 427b in FIG. 15) may be formed on the first stopping member or the second stopping member, and the first hooking protrusions 435a and 435b may face and come into contact with the second hooking protrusions 427a and 427b, respectively, it is possible to prevent the circulation member 430 from not being well separated from the stopping members 425a and 425b due to a locking phenomenon occurring while the surface of the circulation member 430 is in contact with the surface of the stopping member 425.

A guide member 417 may be provided at a point spaced apart from the screw 421 at one side of the seating portion 415, a second through hole 437 through which the guide member 417 passes may be formed in the circulation member 430, and the circular movement of the circulation member 430 may be guided by the guide member 417. In this case, both ends of the guide member 417 may be coupled to the seating portion 415.

Meanwhile, since the movement of the operation unit 300 may be interlocked with the rotation operation using the rotational shaft, the screw 421 may move the operation unit 300 and one side of each of the plurality of phase conversion units 200 connected thereto in the same direction through the driving force transmitted from the motor 410.

In addition, the operation unit 300 may include the plurality of operation bars 310 connecting the plurality of phase conversion units 200 and one or more guide bars 320 connecting the plurality of operation bars 310, and the screw 421 may be connected to any one of the plurality of operation bars 310 to linearly move the operation bars 310 through the rotational force transmitted from any one of the plurality of gears 420.

Although the present invention has been described above in detail through exemplary embodiments, the present invention is not limited thereto and may be variously carried out within the scope of the claims.

1. A phase shifter comprising:
an operation unit connected to a plurality of phase conversion units to synchronize phases changed through the plurality of phase conversion units; and
a driving unit including a motor having a rotational shaft, a plurality of gears rotating in conjunction with the rotational shaft, and a screw connected to any one of the plurality of gears to transmit power to the operation unit, and configured to drive the operation unit through the motor, the plurality of gears, and the screw,
wherein the screw is seated on a seating portion provided outside the motor and pivotally rotates on the seating portion.

2. The phase shifter of claim 1, wherein at least one lubricant member is provided in the seating portion, and the at least one lubricant member reduces friction or wear due to the rotation of the screw between the seating portion and the screw.

3. The phase shifter of claim 2, wherein the at least one lubricating member is made of a material including polytetrafluoroethylene (PTFE), polyether ether ketone (PEEK), or polyetherimide (PEI).

4. The phase shifter of claim 2, wherein the driving unit further includes a circulation member connected to the screw to drive the operation unit by circularly moving on the seating portion according to the rotation of the screw and converting rotational motion of the screw into linear motion.

5. The phase shifter of claim 4, wherein the driving unit further includes a stopping member through which the screw passes at one side or the other side of the seating portion and which restricts a movement range of the circulation member.

6. The phase shifter of claim 5, wherein the stopping member includes a first stopping member and a second stopping member respectively provided at one side and the other side of the seating portion, and the circulation member circularly moves between the first stopping member and the second stopping member.

7. The phase shifter of claim 5, wherein a first through hole through which the screw passes is formed in the circulation member, and when the circulation member circularly moves, the circular movement of the circulation member is stopped by an edge of the first through hole supported by an edge of the stopping member.

8. The phase shifter of claim 7, wherein a first hooking protrusion is formed on an edge of the first through hole, and the first hooking protrusion is supported by being engaged with a second hooking protrusion formed on the edge of the stopping member.

9. The phase shifter of claim 4, wherein a guide member is provided at a point spaced apart from the screw at one side of the seating portion, a second through hole through which the guide member passes is formed in the circulation member, and the circular movement of the circulation member is guided by the guide member.
